(19) United States
(12) Patent Application Publication
(10) Pub. No.: US 2008/0249279 A1
(43) Pub. Date: Oct. 9, 2008

(54) Acid Groups-Containing Polyurethane Resins

(75) Inventors: Anton Arzt, Neutillmitsch (AT); Julius Burkl, Graz (AT); Gudrun Garber, St. Josef (AT); Gerlinde Petritsch, Graz (AT); Markus Schafheutle, Graz (AT); Achim Voelker, Offenbach (DE); Joerg Wango, Wundschuh (AT)

Correspondence Address: CONNOLLY BOVE LODGE & HUTZ, LLP, P O BOX 2207, WILMINGTON, DE, 19899, US

(73) Assignee: CYTEC SURFACE SPECIALTIES AUSTRIA GMBH, Werndorf (AT)

(21) Appl. No.: 11/664,464

(22) PCT Filed: Sep. 27, 2005
(86) PCT No.: PCT/EP05/10410

§ 371 Date: Jan. 2, 2008

(30) Foreign Application Priority Data
Oct. 7, 2004 (EP) 04023925.3

(51) Int. Cl. C08G 18/67

(52) U.S. Cl. 528/75

(57) ABSTRACT

Water-dilutable polyurethane resins with acid groups, wherein the polyurethane resins contain units derived from oils A which are at least partly unsaturated, from olefinically unsaturated aliphatic acids B or anhydrides B′ thereof, from compounds C having functional groups which are reactive towards acid groups or acid anhydride groups, selected from the group consisting of epoxide groups, hydroxyl groups, mercaptan groups and amino groups, and which react in the reaction with the compounds B or B′ to form an ester group, a thioester group or an acid amide group, where the compounds C are selected from the group consisting of compounds C″ which additionally contain sulfonic acid groups, or carboxylic acid groups which are activated by electron-withdrawing substituents, and compounds C′ which additionally contain at least one hydroxyl group which is retained during the reaction with the compounds B or B′, and where at least a mass fraction of 25% of the compounds C consists of compounds C″, and polyfunctional isocyanates D, a process for their preparation, their use as catalysts in the curing of binders containing hydroxyl groups with aminoplast resins, and stoving paints which contain these catalysts

### FIELD OF THE INVENTION

The invention relates to water-dilutable polyurethane resins with acid groups, a process for their preparation and their use as catalysts for curing binders containing hydroxyl groups with melamine-formaldehyde resins.

### BACKGROUND OF THE INVENTION

Curing of resins which contain hydroxyl groups as functional groups can be carried out at room temperature with polyfunctional compounds such as isocyanates, the isocyanate curing agents being added only immediately before the application or even only during the application (two-component binders). It is also possible to employ curing agents which become active only at elevated temperature (one-component binders), resin and curing agent may then already be mixed before the application, and the ready-formulated binders have an adequate storage stability. Catalysts are usually added to accelerate the curing reaction at elevated temperature. Addition of catalysts is always necessary if aminoplast resins are employed as curing agents which are at least partly etherified with low aliphatic linear and branched alcohols having one to four carbon atoms, that is to say reaction products of formaldehyde with aminoplast formers, such as melamine, guanamines, ureas or mixtures thereof. The transetherification reaction which proceeds during the curing is conventionally catalysed by acid. Organic acids such as para-toluenesulfonic acid or derivatives thereof are preferably employed as catalysts. However, such low molar mass compounds can be extracted from the cured lacquer film, and as low molar mass compounds they are subject to the Chemicals Act and new materials legislation.

Therefore, catalysts shall be provided that cannot be extracted from the cured paint film because of their macromolecular character, and which have at least an equally good activity as the known catalysts. Furthermore, they should not adversely influence the mechanical and chemical properties of the cured paint film and should not lead to discolourations or a decrease in the gloss of the paint film.

### SUMMARY OF THE INVENTION

This object is achieved by using educts derived from plant or animal oils for the synthesis of polyurethanes, these educts having in the molecule on average in each case at least one acid group which has a catalytic activity for the curing of aminoplast resins.

The present invention therefore provides water-dilutable polyurethane resins ABCD with acid groups, wherein the polyurethane resins contain units derived from oils A which are at least partly unsaturated, from olefinically unsaturated aliphatic acids B or anhydrides B′ thereof, from compounds C having functional groups which are reactive towards acid groups or acid anhydride groups, selected from the group consisting of epoxide groups, hydroxyl groups, mercaptan groups and amino groups, and which react in the reaction with the compounds B or B′ to form an ester group, a thioester group or an acid amide group, where the compounds C are selected from the group consisting of compounds C″ which additionally contain sulfonic acid groups or carboxylic acid groups which are activated by electron-withdrawing substituents, and compounds C′ which additionally contain at least one hydroxyl group which is not affected during the reaction with the compounds B or B′, and where at least a mass fraction of 25% of the compounds C consists of compounds C″, and polyfunctional isocyanates D.

The present invention also provides a process for the preparation of water-dilutable polyurethane resins ABCD containing acid groups, comprising the steps a) grafting of an oil A with an olefinically unsaturated aliphatic acid B or the anhydride B′ of such an acid, b) polymer-analogous reaction of the adduct AB from step a) with a compound C having functional groups which are reactive towards acid groups or acid anhydride groups, selected from the group consisting of epoxide groups, hydroxyl groups, mercaptan groups and amino groups, which react in the reaction with the compounds B or B′ to form an ester group, a thioester group or an acid amide group, where the compounds C are selected from the group consisting of compounds C″ which additionally contain sulfonic acid groups, or carboxylic acid groups which are activated by electron-withdrawing substituents, and compounds C′ which additionally contain at least one hydroxyl group which is not affected during the reaction with the compounds B or B′, and where at least a mass fraction of 25% of the compounds C consists of compounds C″, and where the use of the compounds C′ is preferred if the graft product AB itself is free from hydroxyl groups or no hydroxyl groups are formed in the graft product AB upon reaction of the acid groups or acid anhydride groups, and c) addition of the products ABC on to the polyfunctional isocyanates D to form a urethane.

The present invention furthermore relates to the use of the water-dilutable polyurethane resins ABCD as a catalyst in the curing of binders containing hydroxyl groups with aminoplast resins, and stoving paints comprising binders containing hydroxyl groups, aminoplast resins and the waiter-dilutable polyurethane resins ABCD.

The acidity of the acid group is measured via its pKa value; if the pKa value is lower than that of acetic acid, the acidity thereof is greater than that of acetic acid.

### DETAILED DESCRIPTION OF THE PREFERRED EMBODIMENTS

Suitable oils A are all the drying and semi-drying oils having at least one olefinic double bond per molecule, in particular oils halving an iodine number of 100 cg/g to 200 cg/g, for example soy beans, linseed oil, rapeseed oil, sunflower oil, tall oil, cottonseed oil, safflower oil, perilla oil and poppyseed oil. Animal oils, such as herring oil, menhaden oil, or sardine oil are also suitable. Linseed oil, perilla oil, wood oil and tall oil are particularly preferred.

Suitable acids B are, in particular, maleic acid, the anhydride thereof, acrylic and methacrylic acid, vinylacetic acid, crotonic acid, itaconic, citraconic and mesaconic acid, and tetrahydrophthalic acid and the anhydride thereof.

Suitable compounds C contain functional groups which are reactive towards acid groups or acid anhydride groups, selected from the group consisting of epoxide groups, hydroxyl groups, mercaptan groups and amino groups, and which react in the reaction with the compounds B or B′ to form an ester group, a thioester group or an acid amide group, where the compounds C are chosen from compounds C″ which additionally contain sulfonic acid groups, or carboxylic acid groups which are activated by electron-withdrawing substituents, and compounds C′ which additionally contain at least one hydroxyl group which is not affected during the reaction with the compounds B or B′, and where at least a mass fraction of 25% of the compounds C consists of compounds C″.

Suitable compounds C1 are therefore those compounds which react with cyclic acid anhydrides under ring-opening or renewed formation of the cyclic structure, such as, for example, hydroxy(alkylene)amines having at least one primary amino group and at least one hydroxyl group, compounds C2 which react with acid anhydrides by addition and formation of a hydroxyl group, such as epoxide compounds, and compounds C3 which react with acids by addition or esterification and contain at least one hydroxyl group which does not react under the conditions of the reaction, by esterification with acids, for example a secondary or tertiary hydroxyl group. Compounds of these classes C1, C2 and C3 additionally contain either at least one sulfonic acid group, or carboxylic acid group which is activated by electron-withdrawing substituents, and then form the class C″, or additionally contain at least one hydroxyl group which is not affected in the reaction with the compounds B or B′, and then fall into class C′. At least a mass fraction of 25%, preferably at least 30%, and in particular at least 40% of the compounds C comprises those compounds C″ which contain at least one acid group which has the effect that the compound C is a stronger acid than acetic acid, such as carboxylic acid groups activated by electron-withdrawing substituents, or particularly preferably sulfonic acid groups. Suitable compounds C′ are, for example, ethanolamine, 2- and 3-propanolamine and N,N-bis-2-hydroxyethyl-diaminoethane. A suitable compound C″ is, in particular, taurine.

Suitable polyfunctional isocyanates D are aliphatic and aromatic isocyanates having at least two isocyanate groups per molecule, in particular diisocyanates, such as aliphatic linear, branched and cyclic isocyanates, such as 1,4-tetramethylene diisocyanate, 1,6-hexamethylene diisocyanate (1-HDI), 2,2,4- and 2,4,4-trimethylhexane diisocyanate, dodecamethylene diisocyanate, 1,4-diisocyanatocyclohexane, 1-isocyanato-3,3,5-trimethyl-5-isocyanatomethyl-cyclohexane (isophorone-diisocyanate, IPDI) and bis-(4-isocyanatocyclohexyl)methane (HMDI), and aromatic isocyanates, such as 2,4- and 2,6-toluylene diisocyanate or a mixture thereof, bis-(4-isocyanatophenyl)-methane, tetramethylxylylene diisocyanate and the isomeric 1,5-, 1,8- and 2,3-naphthalene diisocyanates.

The acidic water-dilutable polyurethane resins obtainable according to the invention can be used, inter alia, in mixtures of water-dilutable binders, and in particular as catalysts in the curing of binders containing hydroxyl groups with aminoplast resins. In this context, it is preferable for the quotient of the mass of the water-dilutable polyurethane resin and the mass of the aminoplast resin to be from 0.5% to 10%.

Preferably, the polyurethane resins have a mass fraction of acid groups of from 0.5 cg/g to 5 cg/g, particularly preferably from 1.0 cg/g to 4.0 cg/g and in particular from 1.5 cg/g to 3 cg/g. The mass fraction of acid groups is calculated by dividing the mass of the acid groups (—SO₃H for sulfonic acids, —COOH for carboxylic acid groups; the ionised acid groups in the protonated form are also included in the calculation here) in the resin by the mass of the resin solid. The value is stated in “cg/g” or “%”.

The invention is explained by the following examples. In the following examples, as in the preceding text, all data with the unit “%” denote mass fractions (quotient of the mass of the substance in question and the mass of the mixture), unless otherwise stated. Concentration data in “%” are mass fractions of the dissolved substance in the solution (mass of the dissolved substance divided by the mass of the solution).

### EXAMPLES

### Example 1

### Preparation of an Adduct of Linseed Oil and Maleic Acid Anhydride

880 g of linseed oil were mixed with 220 g of maleic acid anhydride (MAA). This mixture was heated slowly to 210° C., while stirring and under a nitrogen atmosphere. The mixture was kept at this temperature until free MAA was no longer detectable by titration of the aqueous extract with methyl orange as an indicator. The mixture was then cooled to room temperature.

### Example 2

### Addition of Taurine on to the Linseed Oil-Maleic Acid Anhydride Adduct

9.8 g of taurine were dissolved in a mixture of 8.9 g of ethanolamine and 10 g of deionised water under heating (approx. 80° C.). After the solid had dissolved completely, 30.4 g of triethylamine (TEA) were added to this solution. 110 g of the product from Example 1 were metered into this two-phase mixture over 90 minutes at 80° C. with slowly increasing temperature, the boiling triethylamine condensing and being recycled to the reaction mixture. When the addition had ended, the mixture was heated up to a maximum of 180° C. and the TEA/water azeotrope was distilled off, the TEA being recycled. After 140 g water had been removed from the reaction mixture, the TEA was removed by distillation under reduced pressure. A viscous resin was obtained having an acid number of 37.4 mg/g and an amine number of less than 0.4 mg/g which resin was soluble in water to give a clear solution. A solution of 10 g of the resin in 100 g of the solution has a pH of 3.9.

### Example 3

### Preparation of an Aqueous Dispersion of an Acidic Polyurethane Resin

30 g of the resin from Example 2 and 10 g of castor oil were mixed with 6 g of N-methylpyrrolidone, and the mixture was heated to approx. 40° C. 6 g of toluylene diisocyanate were added to this solution. During this operation the mixture was heated to 70° C. to 72° C. utilising the exothermicity. The mixture was kept at this temperature until an isocyanate concentration of from 1.6% to 1.65% was reached. 2.3 g of diethanolamine were then added and stirred in. Heating to 82° C. was observed during this operation. After renewed cooling to 70° C., the resin was diluted with 87.8 g of deionised water. A very finely divided dispersion having a non-volatile content of 34% and a pH, measured on a solution of 10 g of the resin in 100 g of the solution, of 7.2 was obtained.

### Example 4

### Aqueous Dispersion of a High Molar Mass Chain-Extended Polyurethane Resin

30 g of the resin from Example 2 and 30 g of castor oil were mixed in 11 g of N-methylpyrrolidone, and the mixture was heated to 40° C. First 4 g of toluylene-diisocyanate and immediately thereafter 8.4 g of isophorone-diisocyanate were added to this solution. The mixture was heated to 70° C. to 72° C. utilising the exothermicity, and was kept at this temperature until the isocyanate concentration was between 1.8% and 1.9%. When this concentration was reached, the resin was dispersed with 109.7 g of heated (70° C.) and deionised water. Immediately thereafter, chain-extension was carried out with a solution of 2.6 g of isophorone diamine in 12.6 g of deionised water. After stirring for 120 more minutes, a finely divided dispersion having a non-volatile content of 36%, a viscosity (23° C., 25 s⁻¹) of 87 mPa□s and a pH of 7.6, measured on a solution of 10 g of the resin in 100 g of the solution, was obtained. The mass fraction of acid groups (sulfonic acid groups) was approx. 2.0 cg/g.

### Example 5

### Paint Testing

### Clear Coat Paint:

A clear coat paint having a spray viscosity corresponding to an efflux time of 27 s, measured in a DIN 4 cup at 23° C. (DIN 53 211), was formulated from 75.71 g of ®Macrynal VSM 2872/70 BAC (acrylic resin containing hydroxyl groups), 42.90 g of ®Maprenal VMF 3924/70B (highly reactive melamine resin etherified with methanol and n-butanol and dissolved in n-butanol; both Surface Specialties Germany GmbH & Co KG), 28.50 g of ®Setalux 91756 (acrylate resin; Akzo Nobel Resins NV, hydroxyl number 90 mg/g), as well as the stabilisers 2.50 g of ®Tinuvin 384 and 1.20 g of ®Tinuvin 123 (Ciba Specialty Chemicals), 45.00 g methoxypropyl acetate, and 0.20 g of ®Byk 310 (substrate wetting additive, Byk Chemie GmbH).

### Comparison Catalysts for the Crosslinking Reaction:

CC1: para-toluene sulfonic acid (“PTSA”, Allied Signal-Riedel de Haen), dissolved to give a 50% strength solution in iso-butanol.

CC″: Dodecylbenzene sulfonic acid blocked with an amine (®Nacure 5225, King Industries)

The mass fraction w_{C} of the catalyst is based on the mass of the solid in the aminoplast curing agent ®Maprenal VMF 3924. The catalyst (CC1, w_{C}=1% and CC2, w_{C}=0.8% and the dispersion according to the invention according to Example 4, w_{C}=4%) is added to the finished formulation of the clear coat paint.

### Preparation of the Test Metal Sheets

Degreased gradient metal sheets of rolled steel (DIN 1624, 400 mm×100 mm, thickness 0.8 mm) were sprayed with the solvent-containing primer described below (with an air pressure of 4 bar=0.4 MPa) and the coated metal sheets were stoved for 25 minutes at 140° C.

The primer was formulated from 34.90 g of ®Vialkyd AN 951/70SNA (polyester resin, Surface Specialties Germany GmbH & Co. KG), 16.30 g of titanium dioxide pigment of the rutile type (Kronos Titan), 16.30 g of carbon black (®Printex 300, DegussaHuls AG), 16.30 g of ®Blanc fixe micro (Sachtleben), 0.25 g of ®Aerosil 380 (finely divided silica, DegussaHuls AG), 2.00 g of 2-ethylhexanol, 6.50 g of methoxypropyl acetate and 6.10 g of ®Solvesso 150 (mixture of aromatics having an average boiling temperature of 150° C., Exxon Chemicals), which were ground together in a bead mill at 50° C. and 7,000 min⁻¹ for thirty minutes. 0.20 g of ®Additol XL (Surface Specialties Germany GmbH & Co. KG, flow promoter), 14.80 g of ®Maprenal MF 590/55iBX (melamine crosslinking resin, Surface Specialties GmbH & Co. KG, Germany) and 2.30 g of isobutanol were then added and the mixture was stirred at 2,000 min⁻¹ for a further 20 minutes at 25° C. to 30° C. The viscosity was then adjusted to an efflux time of 27 to 30 seconds from a 4 mm cup (DIN 53211; 23° C.) for spraying by addition of further solvent.

The thickness of the stoved paint film was 40 μm to 50 μm.

A primer coat of an aqueous black paint (“Smaragdschwarz”, DuPont Performance Coatings GmbH & Co. KG) was sprayed on to this primer/filler layer with a pressure of from 0.4 MPa to 0.5 MPa (4 to 5 bar); after drying for five minutes at room temperature and five minutes at 80° C., a dry film thickness of 13 μm to 17 μm was obtained.

Thereafter, the clear coat paint according to the recipe given above was sprayed on under an air pressure of 0.4 MPa (4 bar) and stoved for 20 minutes at 140° C. to give a dry film thickness of from 35 μm to 45 μm.

Appearance (“Wave Scan”, long wavelength and short wavelength fraction), gloss, hardness, elasticity and the resistance to acid and solvents were evaluated on these metal sheets.

To determine the scratch resistance (Amtec-Kistler test) and the sensitivity to overbaking, metal sheets tin-plated by electroplating (180 mm×105 mm, thickness 0.24 mm) were coated with the primer and stoved in the same manner; for the test for overbaking, they were then stoved for a further 60 minutes at 140° C. After the metal sheets had been cooled to room temperature, the base coat and the clear coat paints were applied and the coating was stoved at 140° C. for 20 minutes.

### Test Parameters and Test Means:

1. Surface: A “wave scan plus laboralory” apparatus from BYK-Gardner in D-82534 Geretsried
2. Gloss: Micro-Tri-Gloss gloss meter from Byk-Gardner
3. Adhesion: Cross hatch with 1 mm hatch separation, in accordance with the EN ISO 2409 method, strips of ®TESA 4651 adhesive tape from Beiersdorf, Hamburg were stuck on to the hatched surface and peeled off, evaluation 0: best value, 5 poorest adhesion
4. Acid Test with Aqueous Sulfuric Acid Solution (Mass Fraction of H₂SO₄ in the Solution 10%)
The coated gradient metal sheets were laid on a gradient oven (2615 oven from BYK-Gardner) preheated at 60° C., a 50 μl drop of this acid was applied to the heated metal sheet with an Eppendorf Multipipette (4780) every minute for a test period of 30 minutes, and the metal sheet was then washed off with deionised water. The evaluation is carried out after 24 hours at rest at room temperature. The time until the first damage to the clear coat layer (4.1), until complete destruction of the clear coat layer (4.2), until the first damage to the base coat layer (4.3) and until complete destruction of the structure comprised of the base coat and the clear coat (4.4) were recorded as ratings.
   5. Chemical Resistance in Accordance with the Daimler-Chrysler Test Method PBODC 371 A:
A gradient oven type 2615 from BYK-Gardner was heated up to 30° C. to 80° C., solutions of the chemicals were applied to a painted test metal sheet in accordance with Table 1 and the metal sheet was then laid on the gradient hot-plate for 30 minutes.

TABLE 1
Test chemicals and test conditions

| | Volume | Temperature range | Segment |
|---|---|---|---|
| Substance | in μl | in ° C. | separation |
| H₂SO₄¹ | 25 | 30 to 74 | 1 |
| Pancreatin² | 50 | 30 to 74 | 2 |
| Tree resin³ | 25 | 30 to 74 | 2 |
| Water⁴ | 250 | 30 to 74 | 2 |

Temperature difference: 1 K per heating element.

To remove the tree resin after the action, after cooling to 25° C. the coated metal sheet was cleaned with petroleum ether; all the other chemicals were removed by rinsing off with cold water (15° C.).

After 24 hours at rest, the metal sheets were evaluated by determining the lowest temperature at which a first damage to the clear coat by the chemical in question was to be seen.
1 Sulfuric acid, analytical grade, mass fraction of the acid in the solution 1%
2 Pancreatin (Merck GmbH, Darmstadt, Art. 7130) ground in a porcelain mortar with the same mass of deionised water
3 Tree resin (DuPont Performance Coatings GmbH & Co. KG, Wuppertal)
4 Deionised water

### 6. Elasticity:

Tested with an “Erichsen 202 indentation tester”; the depth of indentation at which the paint film does not tear is stated.

### 7. Scratch Resistance:

Determined with an Amtec-Kistler carwash unit in accordance with DIN 55668. The tin-plated metal sheets are inserted for 10 washing cycles. Thereafter, the metal sheets are rinsed and gloss is measured in accordance with test 2. directly thereafter and after heat treatment at 60° C. for 2 hours (so-called “reflow” condition).

### Recipe of the Clear Coat Paint:

75.71 kg of a hydroxy-functional acrylate resin (®Viacryl VSC 2872, Surface Specialties Germany GmbH & Co. KG, hydroxyl number 145 mg/g, mass fraction of solids 70%, dissolved in butyl acetate) and 28.5 kg of a hydroxy-functional acrylate resin (®Setalux 91756, Akzo Nobel Resins NV, hydroxyl number 90 mg/g) were formulated with light stabiliser, 35 kg of methoxypropyl acetate as a further solvent and 42.9 kg of a melamine-formaldehyde resin etherified with methanol and butanol (®Maprenal VMF 3924, mass fraction of solids 70%, dissolved in n-butanol, average degree of polymerisation 1.5) to give a clear coat paint having a mass fraction of solids of approx. 54%. The efflux time (DIN cup, 4 mm, 23° C.) was 36 seconds, and was adjusted to 27.5 s by addition of a further 10 kg of methoxypropyl acetate (mass fraction of solids 51%). This clear coat paint was divided into four portions, and sprayed as the topmost layer onto the metal sheets prepared according to the above description.

After stoving, Erichsen indentation (6), the resistance to acid (4), gloss (2), surface quality (1), the resistance to chemicals (5), scratch resistance (7) and adhesion (3) were determined in comparison to a non-catalysed clear coat composition.

The following results were obtained in these tests:

TABLE 2
Results of the paint testing

| | | | | | | Resin from |
|---|---|---|---|---|---|---|
| Catalyst | | | none | DDBSA | PTSA | Example 4 |
| Dry film thickness | | | | | | |
| in μm | | | | | | |
| Primer | | | 40 | 43 | 40 | 47 |
| Base coat | | | 16 | 16 | 16 | 15 |
| Clear coat | | | 42 | 44 | 34 | 42 |
| Erichsen indentation | | | 8.8 | 5.5 | 3.4 | 6.6 |
| in mm | | | | | | |
| Resistance to acid | | | | | | |
| in min | | | | | | |
| according to 4.1 | | | 7 | 10 | 11 | 11 |
| according to 4.2 | | | 13 | 13 | 13 | 16 |
| according to 4.3 | | | 14 | 13 | 13 | 16 |
| according to 4.4 | | | 16 | 14 | 14 | 17 |
| Wave scan | | | | | | |
| Long wave, horizontally | | | 5.0 | 7.5 | 20.9 | 5 |
| Short wave, horizontally | | | 9.0 | 36.1 | 49.1 | 8.8 |
| Gloss | | | | | | |
| Observation angle 20° | | | 89.4 | 90.7 | 87.5 | 90 |
| Observation angle 60° | | | 93.6 | 94.3 | 93.7 | 94.6 |
| Resistance to chemicals on a gradient | | | | | | |
| oven in ° C. | | | | | | |
| Sulfuric acid 1% | threshold | 55° C. | 36 | 37 | 37 | 44 |
| Pancreatin | threshold | 55° C. | 56 | 60 | 59 | 57 |
| Tree resin | threshold | 45° C. | 37 | 49 | 61 | 47 |
| Water | threshold | 80° C. | 58 | >80 | >80 | >80 |

| | | | | |
|---|---|---|---|---|
| Amtec-Kistler carwash unit | | | | |
| Gloss, 20°, starting value | 89.6 | 90 | 89.3 | 88 |
| Gloss, 20°, after 10 cycles | 61.5 | 55 | 75.5 | 60 |
| Gloss, 20°, after 10 cycles and heating for 2 h at 60 □C. | 60 | 60 | 73 | 74 |
| Adhesion | | | | |
| Clear coat on base coat | 0 | 0 | 5 | 0 |

It can be seen from the paint tests that the clear coat paints catalysed with the resin of Example 4 without exception show better results in the tests; only in the scratch resistance in the washing unit test without subsequent recovery, “reflow”, is a small advantage found for the clear coat paint catalysed with para-toluenesulfonic acid.

The aim of providing a polymeric catalyst for curing of stoving lacquers with aminoplast resins which is equal to the known low molar mass catalysts has been achieved.

1. Water-dilutable polyurethane resins with acid groups, wherein the polyurethane resins contain units derived from oils A which are at least partly unsaturated, from olefinically unsaturated aliphatic acids B or anhydrides B′ thereof, from compounds C having functional groups which are reactive towards acid groups or acid anhydride groups, selected from the group consisting of epoxide groups, hydroxyl groups, mercaptan groups and amino groups, and which react in the reaction with the compounds B or B′ to form an ester group, a thioester group or an acid amide group, where the compounds C are elected from the group consisting of compounds C″ which additionally contain sulfonic acid groups, or carboxylic acid groups which are activated by electron-withdrawing substituents, and compounds C′ which additionally contain at least one hydroxyl group which is not affected during the reaction with the compounds B or B′, and where at least a mass fraction of 25% of the compounds C consists of compounds C″, and polyfunctional isocyanates D.

2. Water-dilutable polyurethane resins according to claim 1, characterised in that they have a mass fraction of acid groups of from 0.5 cg/g to 5 cg/g.

3. A Process for the preparation of water-dilutable polyurethane resins according to claim 1, comprising the steps
a) grafting of an oil A with an olefinically unsaturated aliphatic acid B or the anhydride B′ of such an acid,
b) polymer-analogous reaction of the adduct AB from step a) with a compound C having functional groups which are reactive towards acid groups or acid anhydride groups, selected from the group consisting of epoxide groups, hydroxyl groups, mercaptan groups and amino groups, and which react in the reaction with the compounds B or B′ to form an ester group, a thioester group or an acid amide group, where the compounds C are selected from the group consisting of compounds C″ which additionally contain sulfonic acid groups, or carboxylic acid groups which are activated by electron-withdrawing substituents, and compounds C′ which additionally contain at least one hydroxyl group which is not affected during the reaction with the compounds B or B′, and where at least a mass fraction of 25% of the compounds C consists of compounds C″, and
c) addition of the products ABC on to the polyfunctional isocyanates D to form a urethane.

4. The process according to claim 3, characterised in that the compounds C′ are employed if the graft product AB itself is free from hydroxyl groups or no hydroxyl groups are formed in the graft product AB on reaction of the acid groups or acid anhydride groups.

5. The process according to claim 3, characterised in that oils A having an iodine number of from 100 cg/g to 200 cg/g are employed in step a).

6. The process according to claim 3, characterised in that maleic acid or the anhydride thereof are employed as the acids B.

7. The process according to claim 3, characterised in that taurine is employed as compound C″.

8. A method of use of the water-dilutable polyurethane resins according to claim 1 comprising adding these resins to a mixture of binders containing hydroxyl groups with aminoplast resins, and heating this mixture to effect curing.

9. Stoving paints comprising binders containing hydroxyl groups, aminoplast resins and the water-dilutable polyurethane resins according to claim 1.

10. The stoving paints according to claim 9, characterised in that the ratio of the mass of the water-dilutable polyurethane resin and the mass of the aminoplast resin is from 0.5% to 10%.
